(19) United States
(12) Patent Application Publication
(10) Pub. No.: US 2002/0051609 A1
(43) Pub. Date: May 2, 2002

(54) Optical terminator device with fibre

(75) Inventor: Tommaso Pensato, Garbagnate Milanese (IT)

Correspondence Address: YOUNG & THOMPSON, 745 SOUTH 23RD STREET 2ND FLOOR, ARLINGTON, VA, 22202

(73) Assignee: OPTOTEC S.P.A.

(21) Appl. No.: 09/884,967

(22) Filed: Jun. 21, 2001

(30) Foreign Application Priority Data
Sep. 15, 2000 (IT) RM2000A000503

(51) Int. Cl. G02B 6/36

(52) U.S. Cl. 385/85; 385/78

(57) ABSTRACT

The optical terminator device according to the present invention comprises a portion of fiber of the same kind of the fiber to be terminated, inserted in a zirconium rod with cup and conveniently lapped on both end surfaces, whereby the end of the fiber portion, which in the connection with the fiber to be terminated, gets into contact with the connector of the latter by means of an optical connector, is lapped like a connector, while the other end is lapped at an angle α with respect to the plane normal to the central axis of the fiber and with a determined degree of sharpness.

The present invention concerns an optical terminator device with fibre, which, due to the easy and consolidated technologic process, allows obtaining low cost products with good performances.

It is well known that the optical terminations have been developed for absorbing the light coming from not terminated connectors, thus minimizing the reflected power that could modify the correct working of the laser sources. Such devices are used in optical networks e.g. in the presence of connector plugs accessible to non connected or open users, in cupboards, in transmission modules, in optical exchangers, in user terminations or in a point-multipoint connection (PON networks) for terminating the non connected parts of optical couplers.

U.S. Pat. No. 4,998,795 AMP Inc. describes a device for optical terminations (reflection-less terminator) in which a portion of fibre is used of the same kind of the one to be terminated. The front part of the fibre gets inserted into a rod mounted in a mechanical body having a plug-shape, while the opposite part of said fibre gets cut in a determined angle, by means—e.g.—of a pocket-knife and then completely immersed into an opaque adhesive substance having the function of absorbing the light reflected by said fibre.

In U.S. Pat. No. 5,619,610 Lucent Technologies an optical terminator is described in which a solid cylindrical structure out of polymeric material is used, with a refraction index similar to the one of an optical fibre. The end of the device, placed onto a cylindrical rod, is solid for a predetermined distance, for obtaining a fading out of at least 20 dB.

It is the aim of the present invention, in a first variant thereof, to make use of an art of fibre inserted in a connector rod opportunely lapped on both outer sides, without the use of additional opaque means for absorbing the light.

A second solution provides the use of a portion of fibre faded out of at least 10 dB/cm and inserted inside a rod for optical connectors.

The present invention will be described more in detail hereinbelow relating to the enclosed drawings in which some embodiments are shown.

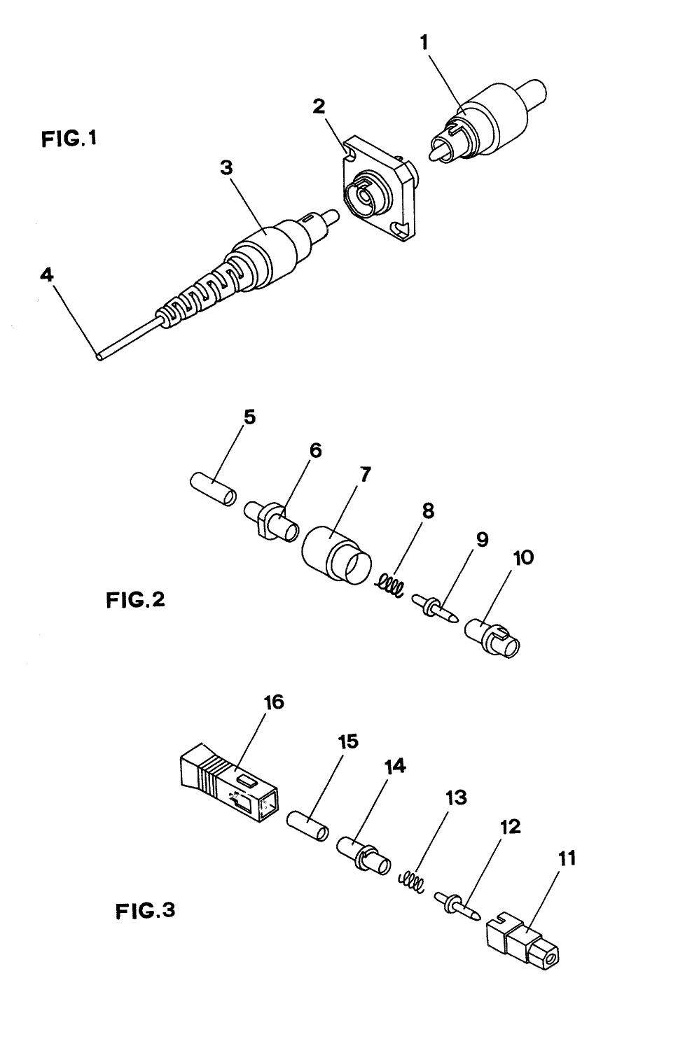

FIG. 1 shows an axonometric view of an optical termination with elements FC.

FIGS. 2 and 3 show an exploded view of the components of the optical terminators, respectively FC and SC.

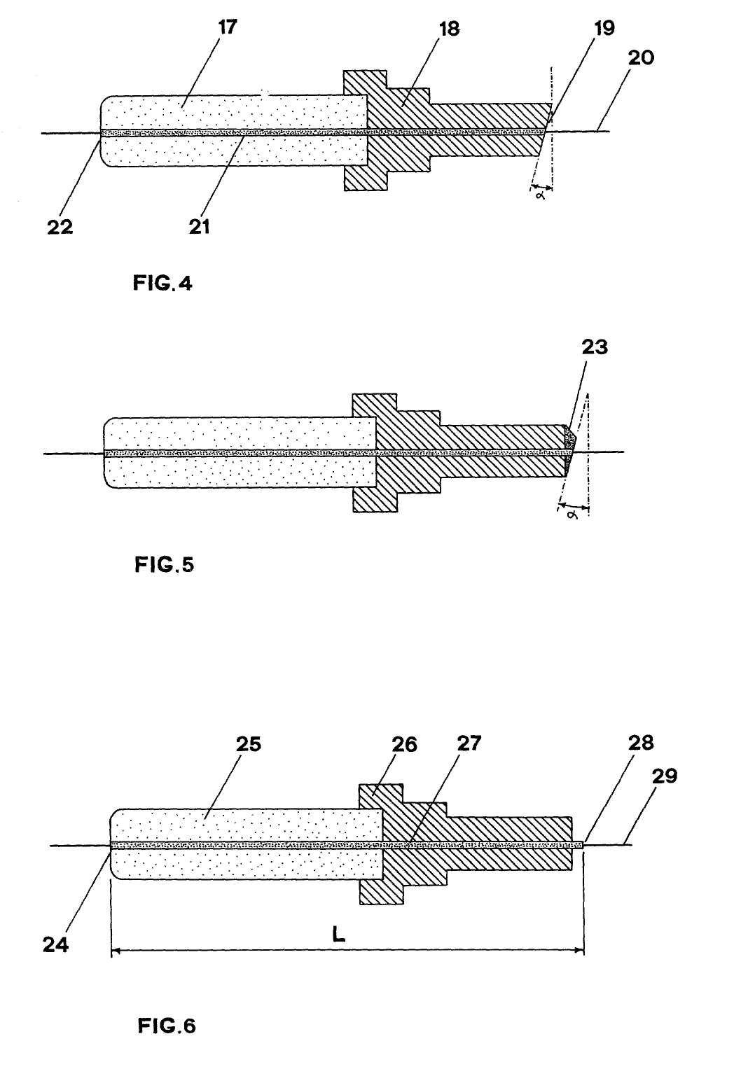

FIGS. 4 and 5 show a lateral section of an angle lapping, respectively on the cup and on the resin bubble.

FIG. 6 shows an optical terminator with a faded out fibre.

The optical terminations according to FIG. 1 are perfectly consistent with optical connectors 3, of the kind SC, ST, FC etc., and therefore they may also be placed in interface with converters 2 of known kind.

In both variant according to the present invention, the same optical and mechanical components are used as for assembling the connectors as shown in FIG. 2 and 3, with the known plug shape 1, typical of the actually used connectors, while the end part of a fibre 4 onto which the reflection loss are to be faded out—i.e. onto which the optical termination is to be realized—must be provided with a plug 3 like a connector FC, as it usually occurs in optical systems. The optical termination according to FIG. 1 is obtained by connecting said plug 3 to terminator 1 through a usual converter 2 for optical connectors. Of course, the latter will be used according to the topology of the used devices, so as to allow the correct connection between the mechanical systems. This means that also connections between terminators and connectors of different kinds are possible (e.g. SC-FC, SC-ST, ST-FC etc.), when the optical connector is of a hybrid kind.

The realization of the optical terminator 1 is based on the use of a portion of fibre of a determined length.

Hereinbelow, two different solutions will be described for implementing an optical terminator that may be easily assembled in any mechanical body used for the best known optical connectors.

In an optical terminator with a normal fibre, as shown in FIGS. 4 and 5, a portion of fibre 21 is used that is equal to the one to be terminated. The piece of fibre 21 for said optical terminator gets inserted into a rod 17 and cemented, e.g. with a resin, in the same way as for the optical connectors. In said connectors, usually zirconium rods are used, and one end thereof is hooked to a cup 18 of plastic or metal material and that has a purely mechanic function. The portion of fibre to be used must be of such a length as to project from both ends 19 and 22 of the unit rod-cup. Therefore, that end 22 of the rod which is in contact with the connector 3 of the fibre 4 to be terminated gets lapped with the portion 21 of said fibre, according to the rules usually followed for realizing optical connectors. Therefore, according to the kind of lapping of the contact surface of the end 22 of the rod, return loss values are obtained that decrease starting from lappings PC to lappings APC. It is necessary to further reduce the reflection losses, for obtaining devices that realize optical terminations, until the current requirements for these kinds of components are reached.

The solution suggested for further reducing the reflection losses consists in opportunely lapping also the opposite portion 21 of the fibre, i.e. the one that projects from cup 18. The lapping is performed at a determined degree of sharpness and at a determined angle a with respect to the normal plane of the central axis 20 of fibre 21, or—as an equivalent—of cup 18. The return loss reduction thus obtained depends on the angle α and on the roughness degree of the lapping. These are, therefore, the two parameters onto which an intervention is required for controlling and determining the performance of the optical terminator.

From an analytic point of view, such a working of the surface of end 19 of the fibre or, as an equivalent, of the cup allows to deflect the reflected beam at an angle greater than the acceptance angle of fibre 21, so that the greatest part of the optical power gets lost in the coat and not retro coupled in the nucleus.

The Fresnel relation expressing the correlation between the width of the reflected field and of the incident one, in coincidence with the discontinuity of the refraction index of the material at the surface of said end 19, may be analytically expressed as follows:

$${R}_{0} = {( \frac{cos α - \sqrt{{n}^{2} - {sin}^{2} α}}{cos α + \sqrt{{n}^{2} - {sin}^{2} α}} )}^{2}$$

wherein η shows the refraction index of the nucleus, whereas α is the inclination angle of the mentioned discontinuity surface. As can be seen, with α growing also the fraction of reflected power increases and the reflection angle of the light grows proportionally. At this point, the part of reflected optical power is considered that remains confined in the nucleus of fibre 21 and determines the real return loss of the terminator. Assuming a Gaussian distribution of the optical power that propagates in the fibre, the air reflection of an angled fibre may be expressed as follows:

Rₛ=R₀·e^{-w}

wherein

w=(ηKw₀α)²

$${w}_{0} = \sqrt{\frac{\sqrt{2 a}}{nK \sqrt{Δ}}}$$

$$K = \frac{2 π}{λ}$$

α=radius of the nucleus,

Δ=difference between the index of the nucleus and the one of the coat,

λ=wave length.

By replacing the expression of R0 in the expression of RS, the trend of the return loss according the lapping angle α may be obtained.

In a simulation of said relation, an appreciable reduction of the reflection losses may be found with a lapping angle α>8°. For improving the performances of the device according to the present invention, it is sufficient to increase the lapping angle α of end 19 of the fibre portion 21.

With α of about 16° and a lapping degree of the fibre's surface of 0.5 μm—e.g.—a return loss reduction may be obtained of more than −10 dB. Therefore, using these values, an optical terminator may be obtained having reflection losses as follows:

1. RL<−55 dB with PC rods

2. RL<−60 dB with UPC rods

3. RL<−65 dB with APC rods.

These RL values widely respect the current requirements for this kind of device and therefore allow to avoid other devices like the use of opaque means or index matching for reducing reflection losses.

It is obvious that the value of α may be extremely increased so as to obtain lower and lower RL values. This, in turn, means higher lapping times, because the material to be exported also increases, with a consequent increase of the production costs. Therefore, it is necessary to find a correct compromise between the performances required from the device according to the present invention and the costs for the realization thereof.

The lapping time depends from said angle α but also from the kind of cup 18 used for the rod 17, as the working of the end part of the portion 21 of the fibre comprises also the surface of the end 19 of the cup, from which the fibre projects.

For reducing the lapping time it may be avoided to take away material from the cup, leaving an excess of resin 23 used for cementing the fibre, on the end 19 from which it projects. In its liquid phase, the resin gets expanded so as to form a bubble. Thus, in a few ten seconds, it will be possible to tae away the material necessary for creating an angle α to the end surface of that portion of fibre that is immersed in the resin bubble 23, without even touching the cup.

For protecting the optical terminator 9, 12 from external inconveniences that could slope down its performances, like mechanical stress, chemical agents, dust etc., a crown 5, 15 is hooked to the mechanical body that seals the device.

In the variant of an optical terminator with a faded out fibre 27, as shown in FIG. 6, a portion of faded out fibre of a determined length “L” is used which, as in the preceding solution, gets inserted into a zirconium rod 25, opportunely lapped at the end 24, and that will get into contact with the connector 3 of the fibre 4 to be terminated. On the other hand, the other end 28 gets cut normally to the central axis 29 of the fibre 27, or with a determined angle.

The light that gets into the portion of fibre 27 propagates in the guide and will be faded out of such a quantity, expressed in dB/cm, that depends on the kind of doping and on the length of said fibre 27. The incident light on the surface of end 28 of faded out fibre 27 is partially transmitted and partially reflected. The latter is further faded out by the portion of fibre 27 of the same amount as the preceding one, thus minimizing the reflection losses of the device according to the present invention.

If AL shows the fading out for each length unit of the fibre 27, expressed in dB/cm, RLIN (dB) the return loss on the surface of the inlet rod, and RLOUT (dB) the return loss on the surface of the end 28 of the fibre 27, the amount of the reflection losses shown by the device RL (dB) are given, as an absolute value, by the following expression:

RL (dB)=RLIN(dB)+AL(dB/cm)×2L(cm)+RLOUT(dB).

And therefore, opportunely choosing in the project of the optical terminator according to FIG. 6, the preceding parameters, i.e. the fading out per length unit and length L of the faded out fibre 27, the desired return loss RL values may be obtained.

By making use of the zirconium rods 25, which are commonly used in optical connectors, the axial length whereof—comprising the cup 26—is of about 2 cm, a faded out fibre portion 27 may be chosen, e.g., with a length L=2 cm. The light that gets into the optical terminator and that then is reflected therefore runs an optical way of about 4 cm. If the fibre 27 has a typical fading out of 10 dB/cm, the light reflected by the device undergoes a fading out of 40 dB. It might be convenient to choose faded out fibres with at least 10 dB/cm, so as to avoid too high values of length L for the conventional housing in the mechanical plug-shaped body as shown in FIGS. 2 and 3, for obtaining the required performances, thus obtaining devices with extremely low return loss values.

This solution also provides a crown 5, 15 hooked to the mechanical body for protecting the optical terminator 9, 12 from external inconveniences.

1. An optical terminator device, characterized in a portion of fibre of the same kind of the fibre to be terminated, inserted in a zirconium rod with cup and conveniently lapped on both end surfaces, whereby the end of the fibre portion, which in the connection with the fibre to be terminated, gets into contact with the connector of said fibre by means of an optical connector, is lapped like a connector, while the other end is lapped at an angle α with respect to the plane normal to the central axis of the fibre and with a determined degree of sharpness.

2. A device according to claim 1, characterized in that the reduction in terms of reflection losses obtained by lapping at an angle the end of the fibre portion, depends on the angle α and on the lapping sharpness, while an appreciable reduction of return loss is obtained by α>8°, with a lapping and a roughness degree in an order of some hundred nm.

3. A device according to claim 1, characterized in an optical terminator obtained by a portion of faded out fibre of a convenient length, inserted in a zirconium rod with cup, said rod being lapped with the fibre like the optical connectors, while the other end of the faded out fibre is normally cut at the central axis or at an angle.

4. A device according to claim 1, characterized in the presence of a faded out fibre with a fading out per length unit of at least 10 dB/cm, so as to avoid too high length L values.

5. A device according to claim 1, characterized in an outer mechanical body showing a plug shape and wherein the single mechanical components are the same of the optical connectors.
